(19) United States
(12) Patent Application Publication
(10) Pub. No.: US 2020/0070261 A1
(43) Pub. Date: Mar. 5, 2020

(54) ERGONOMIC CUTTING TOOL

(71) Applicant: JOSEPH GORE, Hayden, ID (US)

(72) Inventor: JOSEPH GORE, Hayden, ID (US)

(21) Appl. No.: 16/537,429

(22) Filed: Aug. 9, 2019

Related U.S. Application Data
(60) Provisional application No. 62/716,418, filed on Aug. 9, 2018.

(51) Int. Cl. B23D 27/02; A01G 3/00; B26B 17/00

(52) U.S. Cl. CPC B23D 27/02; B26B 17/00; A01G 3/00

(57) ABSTRACT

What is disclosed is an improved cutting tool to provide improved cutting of small diameter materials, such as stems of flowers and other plants. The device provides a cutting mechanism that is parallel to or in the same plane of a circumference of a ring that is worn on the user's finger. This provides for an increased ergonomic cutting tool. The cutting tool has a blade and an opposing portion that is configured to retain the material to be cut while the blade is pressed into the material or the material can be pushed onto the blade. The device is preferably constructed of a unitary molded plastic with an integrated blade formed in the material.

### PRIORITY/CROSS-REFERENCE TO RELATED APPLICATIONS

This application claims the benefit of U.S. Provisional Application No. 62/716,418, filed Aug. 9, 2018 the disclosure of which is incorporated by reference.

### TECHNICAL FIELD

The presently disclosed technology relates to an improved hand held cutting tool. More particularly, the present invention is a cutting tool for use in a variety of situation, including in gardening.

### BACKGROUND

A variety of cutting tools are known to assist a gardener in the garden. These cutting tools are used, for example, for cutting fruit off of vines, cutting fruit off of the plant, cutting flowers from their stems, and a variety of other purposes. However, many of the tools are awkward to use and are not comfortable to use. What is needed is a cutting tool that is ergonomic, easy to carry, and that provides a user with the ability to rotate the tool out of the user's palm and thus out of the user's way while working. What is further needed is a tool that utilizes a cutting blade to cut vines and stems but provides an inherent safety device to help avoid accidents in which a user's finger or other non-intended object is cut.

### BRIEF DESCRIPTION OF THE DRAWINGS

FIG. 1 is a side view of an embodiment of a cutting tool.

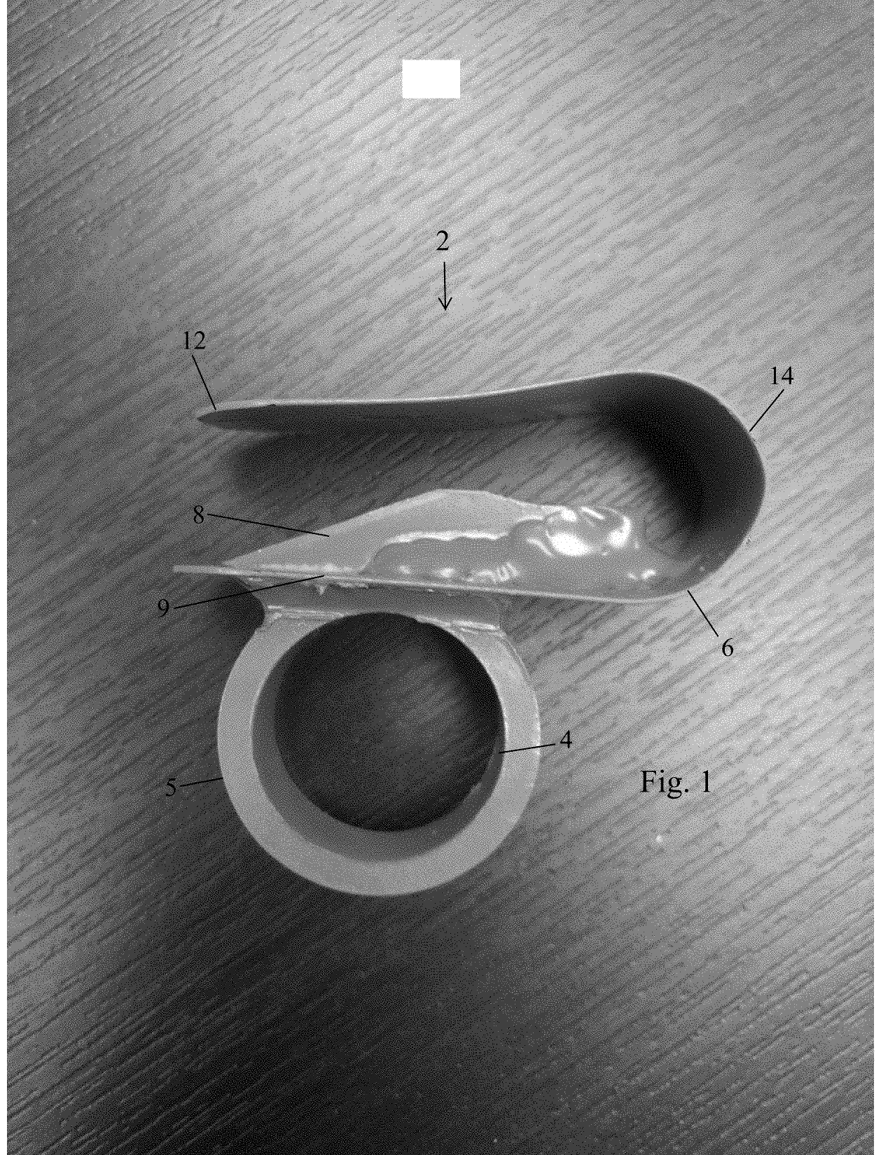

FIG. 2 is a side view of an embodiment of a cutting tool worn on a user's finger.

FIG. 3 is a top view of an embodiment of a cutting tool worn by a user.

FIG. 4 is a side view of an embodiment of a cutting tool worn on a user's finger with the upper section depressed by user's thumb.

FIG. 5 is a front perspective view of an embodiment of a cutting tool.

FIG. 6 is side perspective view of an embodiment of a cutting tool worn by a user cutting the stem of a flower.

FIG. 7 is a top perspective view of an embodiment of a cutting tool worn on a user's middle finger.

FIG. 8 is a side perspective view of an embodiment of a cutting tool worn on a user's middle finger.

FIG. 9 is a bottom perspective view of an embodiment of a cutting tool worn on a user's middle finger.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

What is disclosed is a cutting tool 2 that has a base ring 4. The ring 4 is configured to fit on a user's finger. In a preferred embodiment the ring 4 can be a ring shaped device such as a broken ring to allow for the ring to expand to accommodate varying finger sizes. The ring has a circumference 5. Preferably the circumference ring has a cross section in an oval shape or a ror an interior domed fit similar to a comfort fit wedding ring to promote comfort of the user. The circumference of the ring defines a first plane 7. A cutting unit 6 is attached to the outer portion of the circumference of the ring. The cutting unit is attached such that the longitudinal axis 9 of the cutting unit is oriented in the same plane as the circumference of the ring 5. This provides an ergonomic cutting tool and facilitates ease of use. The ring is preferably constructed of a one piece molded plastic unit with a cutting edge affixed or formed on the interior of the ring.

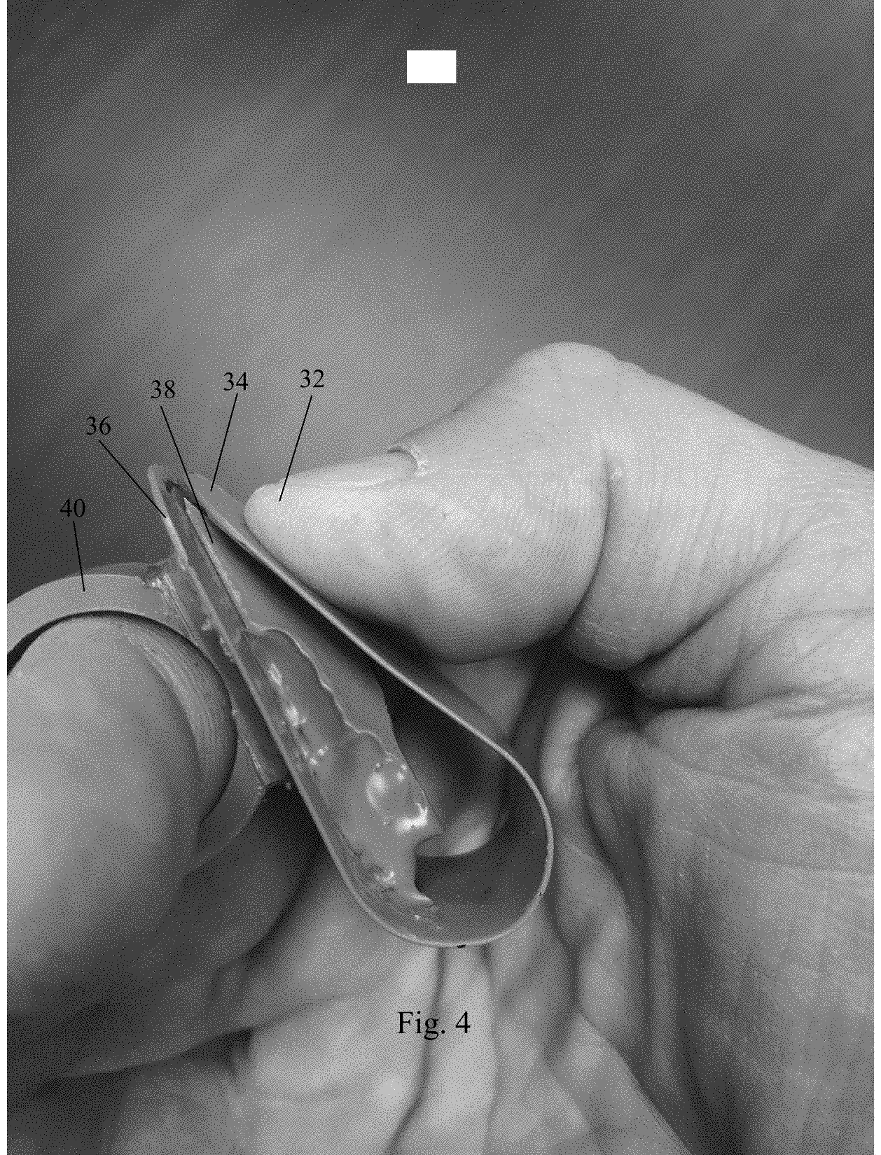

In a preferred embodiment the cutting unit 6 has a base section 9 and a top section 12. These correspond to a first arm of the U-shaped or V-shaped cutting unit and a second arm of the U-shaped or V-shaped cutting unit. The base section and top section are biased apart. In a preferred embodiment biasing is via a curved section 14 that operates as a biasing device or spring like function. A blade 8 is positioned between the lower section 9 and upper section 12 such that a user depressing upper section 12 pushes the upper section 12 toward the blade and thus any material between the upper section 12 and the blade 8 is forced onto the blade and cut. Alternatively used terminology herein is that the first arm and the second arm are biased together or toward one another, which includes depressing the first arm toward the second arm. The upper section in the depicted embodiment is a flat section configured for pushing material toward the blade. As shown, the cutting unit in a preferred embodiment has a generally U-shape; however the cutting unit can be provided in a V-shape or other shape congruent with the concepts disclosed herein. The flat section of the upper section or second arm is configured such that when compressed against the blade, the length of the cutting section of the blade is mated against the flat section, as shown in FIG. 4.

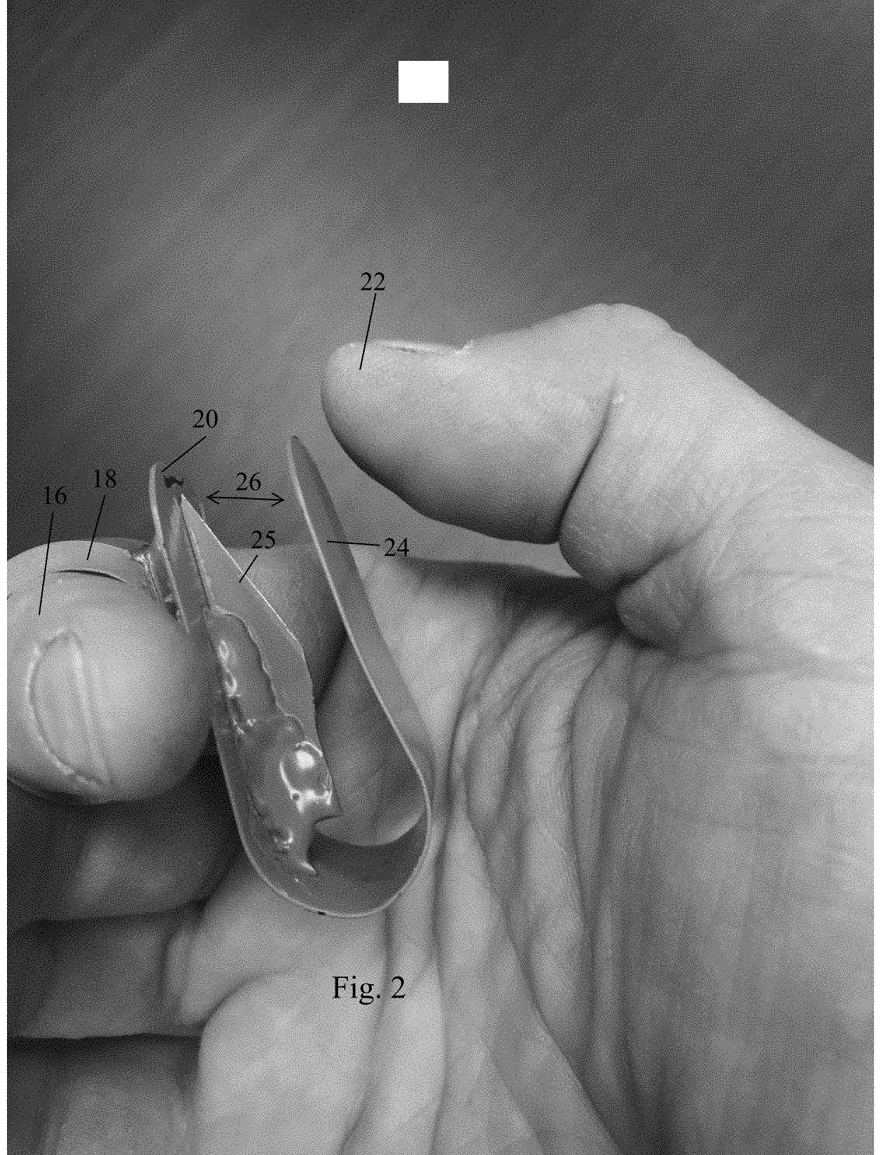

FIG. 2 illustrates the cutting tool in an operable position on a user's hand. The user is wearing the ring 18 on the user's index finger 16. The lower piece 20 of the cutting unit is separated from the upper piece 24 by a gap or cavity 26. The lower section of the cutting unit is affixed to or integral with the lower section 20. The blade 25 is affixed to the lower section 20. Alternatively the blade 25 could be affixed to the upper section 24. The cutting unit is shaped such that a depression by the user's thumb 22 of the upper unit 24 presses the upper unit 24 toward the blade. The U-shape allows for the blade in the upper unit to be generally parallel to the blade such that the entirety of the blade is touching the upper unit as shown in FIG. 4. This provides an elongated cutting area.

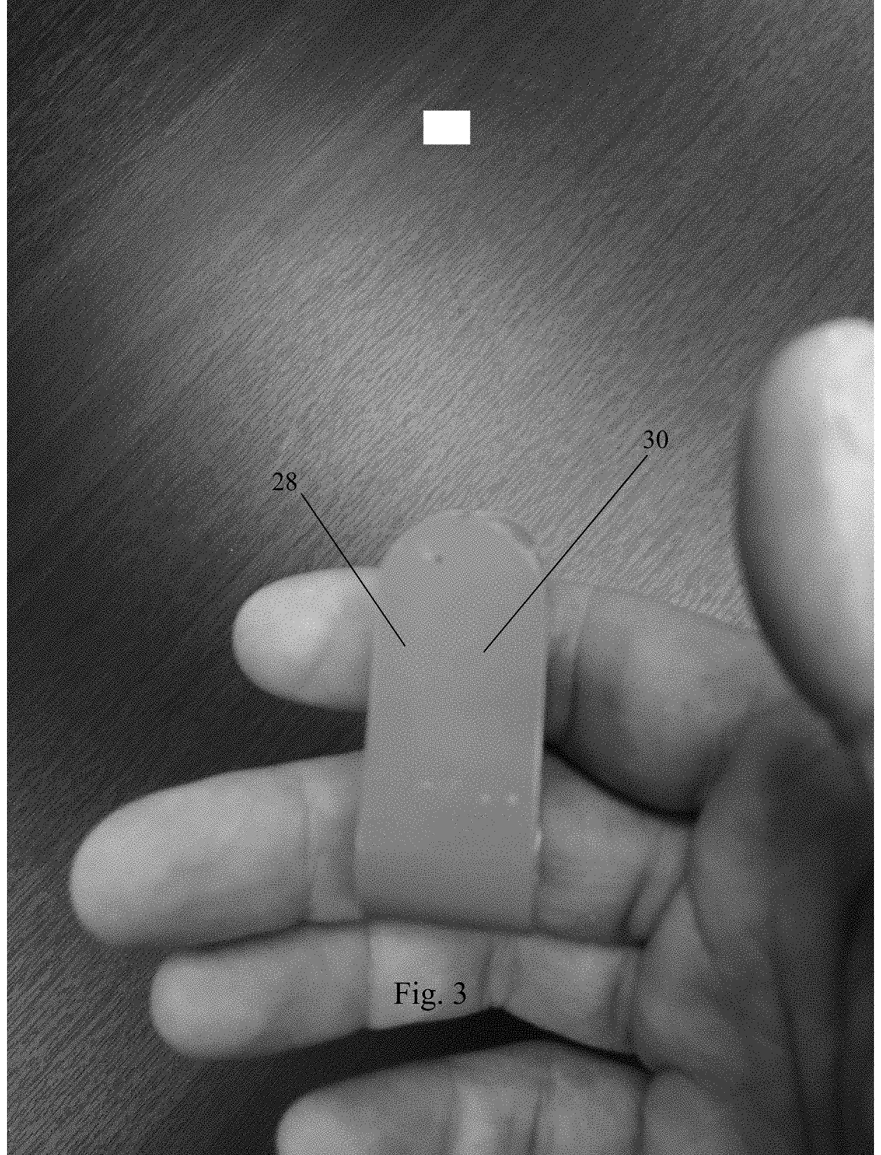

FIG. 3 illustrates the orientation of the cutting unit to a user's hand when the ring (not shown) is worn on a user's index finger. This allows the longitudinal aspect of the cutting unit to be generally perpendicular to the finger upon which the ring is worn. This provides for more ergonomic use and allows for the cutting unit to be rotated to the top side of the user's finger to be out of the way for when the user is performing a task requiring the user's hands to grasp an object. This further provides for the user's thumb to be able to depress the upper section to cut an object. FIG. 3 depicts the cutting unit 30 in a generally perpendicular orientation to the length of the user's finger 28.

FIG. 4 depicts the cutting tool in which the upper unit 34 is being depressed towards the lower unit 36 by a user's thumb 32. Depressing the upper unit forces the upper unit 34 toward the lower unit 36 and blade affixed to lower unit 38. In the depicted orientation, the upper unit is generally in a parallel orientation to the angle of the blade. The ring 40 is shown around a user's finger. Preferably the flat section of the first arm or upper section presses against the entirety of the cutting surface of the blade. This maximizes the cutting surface of the blade.

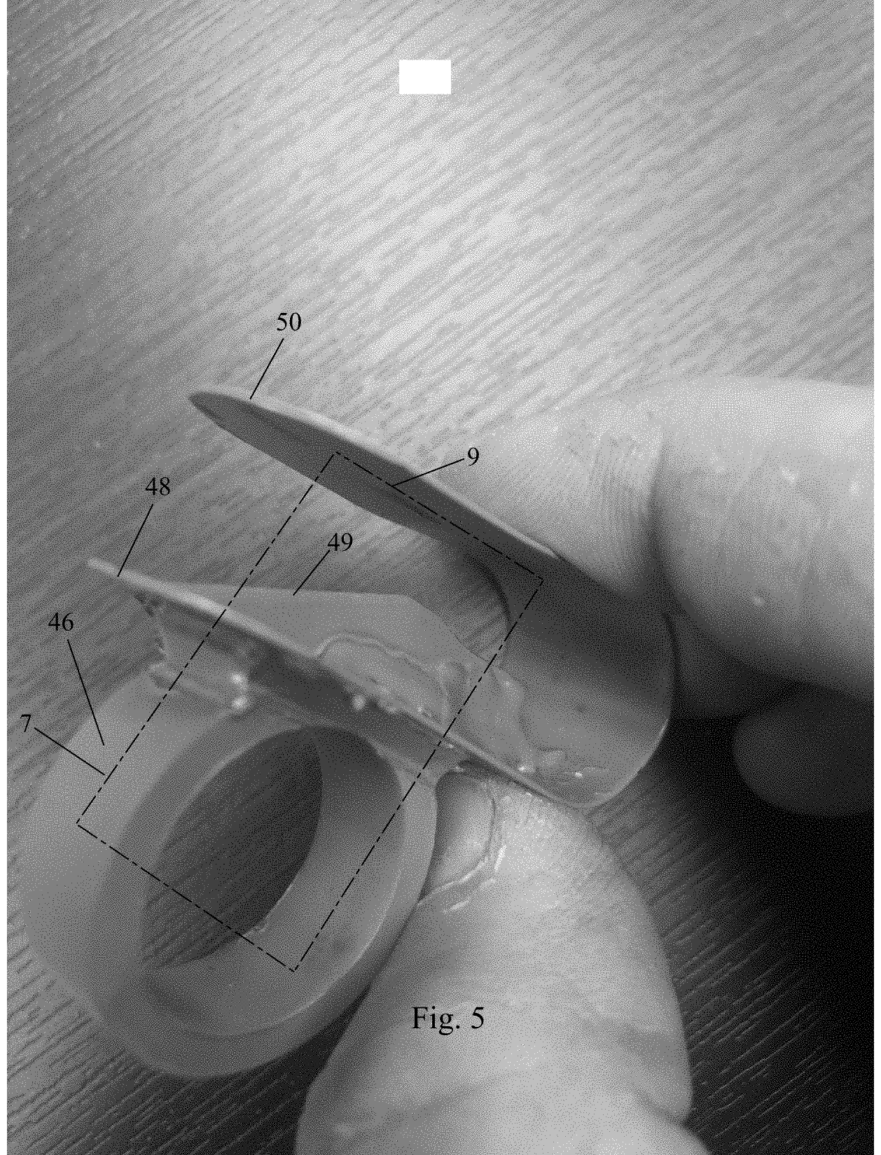

FIG. 5 illustrates a front perspective view of an embodiment of the invention. Upper unit 50 is shown biased apart from the lower unit 48 illustrating blade 49 affixed to the lower unit. The lower unit is affixed to the ring 46 in an orientation in generally the same plane 7 as the circumference of the ring 46.

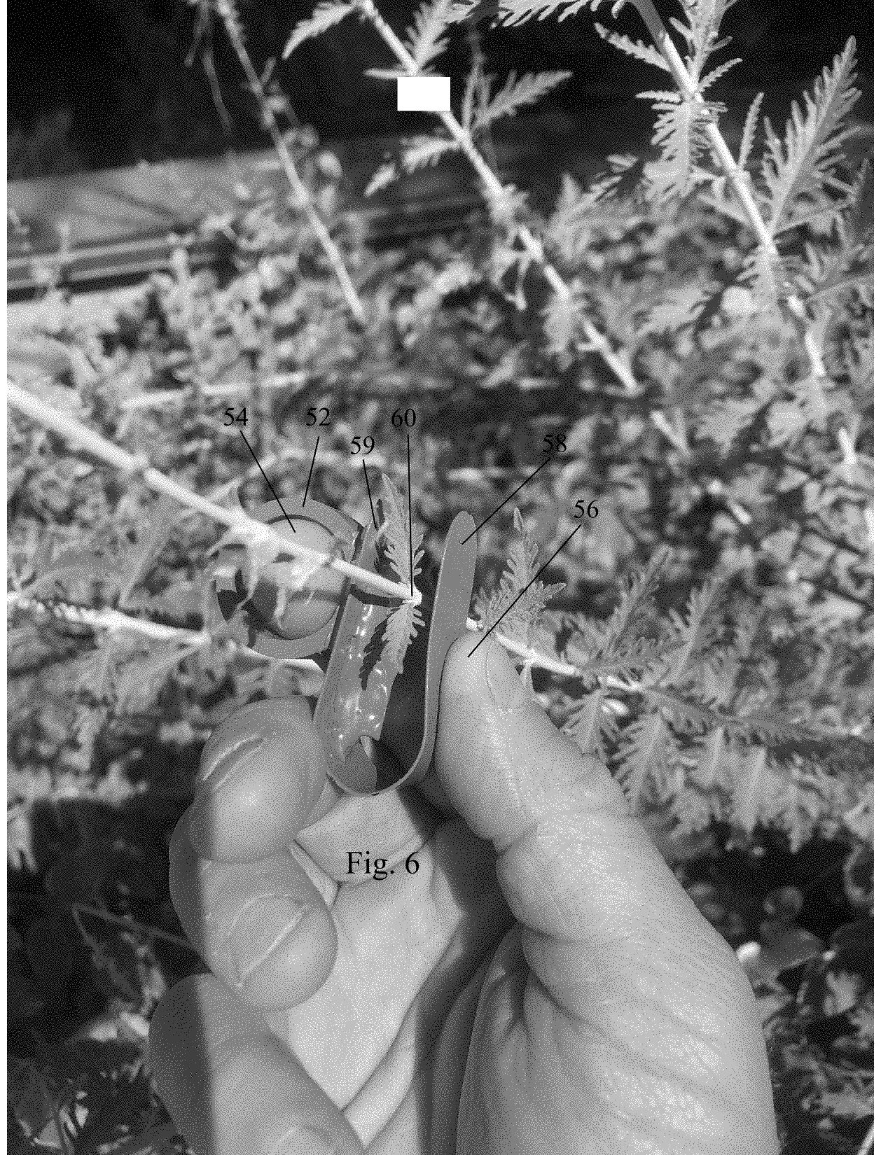

FIG. 6 illustrates a preferred embodiment of the cutting device being used to cut a stem of a flower, in this case, a Russian Sage. The stem of the flower 60 is placed between the upper unit 58 and the lower unit 59. The blade is between the upper unit and the lower unit depressing of the upper unit 58 by the user's thumb 56 depresses the unit and forces the stem of the flower onto the blade thus cutting the stem of the flower. The user's finger 54 is positioned within ring 52 to hold the device in the user's hand. After the blade cuts the flower stem, the user releases pressure from the user's thumb and the biasing device, in this case, the U-shape, biases the upper unit 58 apart from the blade and lower unit.

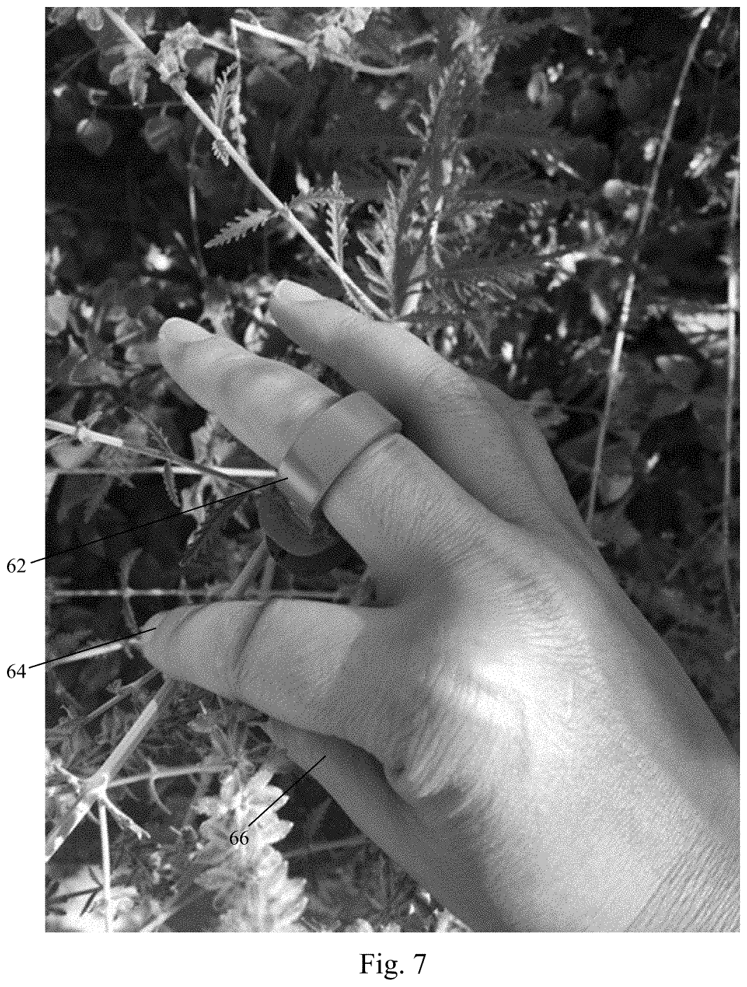

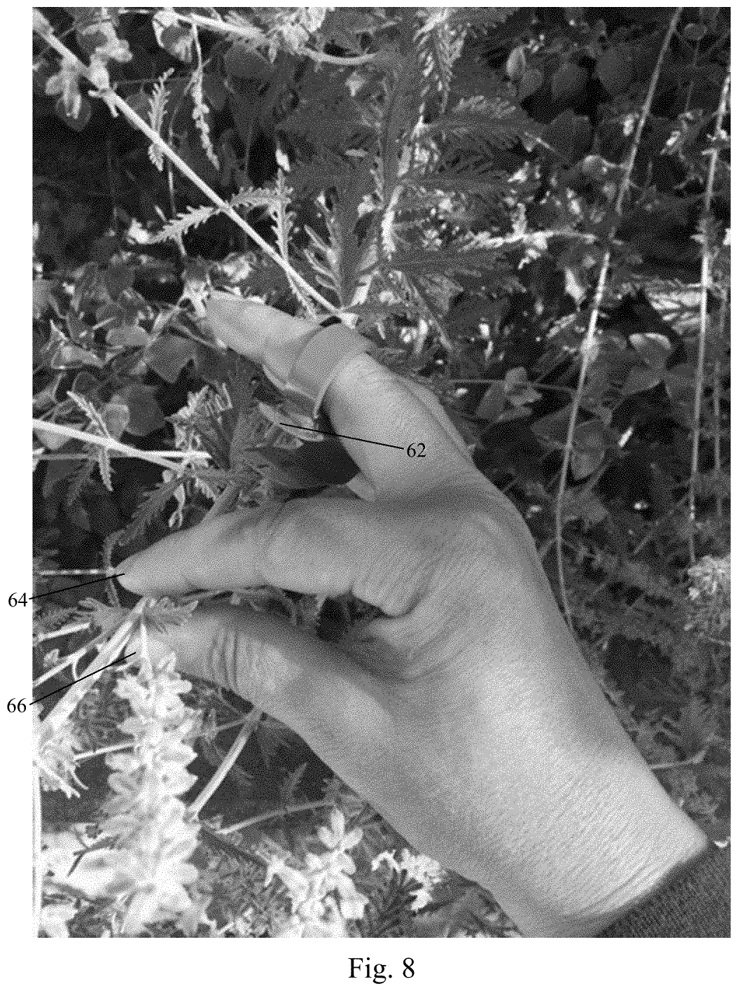

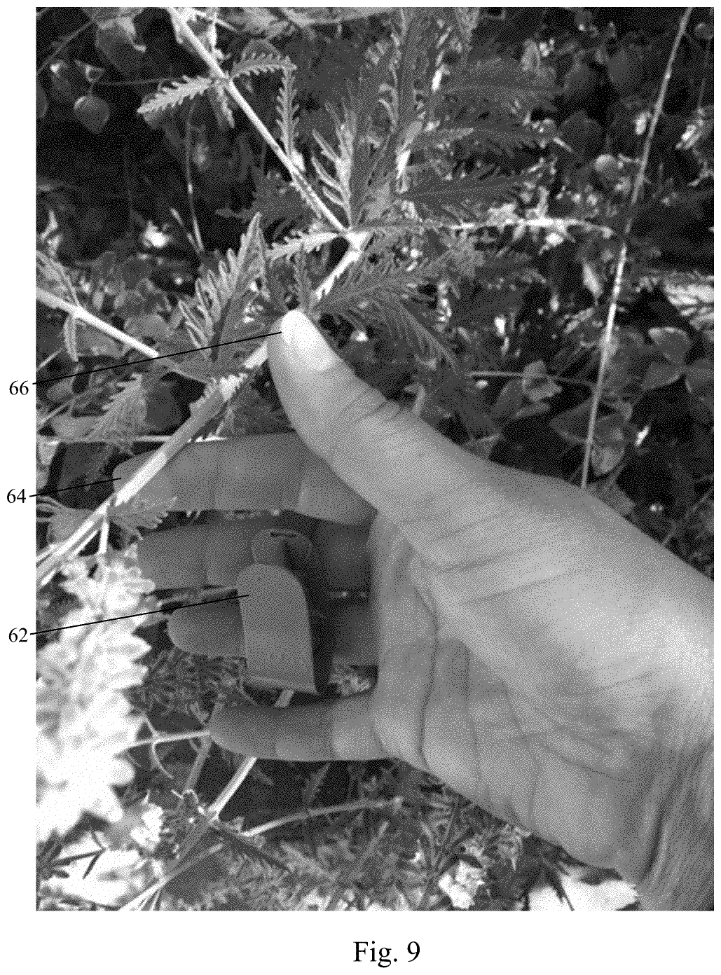

FIGS. 7-9 illustrate a preferred embodiment of the cutting device 62 worn on a user's middle finger while in use. When in use the tool is worn on the middle finger and therefore kept apart from the user's index finger 64 and thumb 66 which can be used to sort through stems and leaves to determine what needs to be cut. This is a major benefit of the tool as other scissors or clippers known to the inventor do not provide for this type of unimpeded finger movements.

The device can be constructed using a variety of materials such as molded plastic or injected plastic, metal, or any other material that could be used. The ring can be a full ring as depicted or a half ring or three-quarter ring or other shape provided that the ring is able to be positioned on a user's finger. The ring can be open to accommodate varying finger sizes. Alternatively the ring can be manufactured in a variety of sizes to accommodate various user finger sizes. A variety of textures could be used on the upper member 58 to provide added friction between the user's thumb and the surface of the upper unit. This could include rubber or other material or texture. It is thought that providing the blade within the U-shape or V-shape of the cutting device will facilitate protection of the blade and of unintended foreign objects from encountering the blade.

Still other features and advantages of the presently disclosed and claimed inventive concept(s) will become readily apparent to those skilled in this art from the description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is claimed is:

1. a cutting device comprising:
a ring, said ring being configured to be positioned on a user's finger, said ring comprising a circumference, said circumference defining a plane;
a cutting unit, wherein said cutting unit comprises an upper section and a lower section biased apart, wherein said upper section and said lower section define a length wherein said cutting unit is attached to said ring, wherein said cutting unit is attached to said ring such that said length of said cutting unit is oriented in the same plane as the circumference of said ring, wherein said upper section and said lower section are biased apart, wherein said cutting unit comprises a blade positioned between said upper unit and said lower unit and attached to one of said upper unit and said lower unit, wherein said blade extends along said length of said cutting unit, wherein said blade is attached to said lower section of said cutting unit, wherein said upper unit comprises a generally planar section free of a blade and configured such that when said upper section and said lower section are biased together to close said gap between said blade and said upper unit, a material to be cut is

2. The cutting device of claim 1, wherein said blade is configured to be removable.

3. The cutting device of claim 1, wherein said ring is an open ended ring.

4. The cutting device of claim 1, wherein said cutting unit comprises a U-shape.

5. The cutting device of claim 1, wherein said cutting unit comprises a V-shape.

6. The cutting device of claim 1, wherein said cutting unit comprises a unitary molded plastic.

7. The cutting unit of claim 6, wherein said blade is configured to be removable.

8. The cutting unit of claim 7, wherein said blade is configured from said unitary molded plastic.

9. The cutting unit of claim 1, wherein said ring comprises a comfort fit.

10. The cutting device of claim 1, wherein said an outer surface of said upper section of said cutting unit comprises a material configured for enhancing friction between a user's thumb and said upper unit section.

11. A cutting device, said cutting device comprising:
A cutting unit, said cutting unit defining a generally u-shaped profile defining a valley and a first arm and a second arm, wherein said first arm and said second arm are biased apart; wherein said first arm and said second arm define a length extending from said valley, wherein said first arm comprises a cutting blade on an interior surface of said first arm, wherein said second arm comprises an inner surface configured to retain an item to be cut by said cutting blade when said first arm and said second arm are biased toward one another;
a ring configured for wearing on a user's finger, wherein said cutting unit is attached to said ring on an outside of one of said arms of said U such that a length of said arms of said U are in a plane defined by a circumference of said ring, wherein a first arm comprises a cutting blade, wherein a second arm comprises a generally planar, wherein said first arm and said second arm are configured to be biased together when a user exerts force on an outer surface of one of said arms.

12. The cutting device of claim 11, wherein said blade is configured to be removable.

13. The cutting device of claim 11, wherein said ring is an open ended ring.

14. The cutting device of claim 11, wherein said cutting unit comprises a U-shape.

15. The cutting device of claim 11, wherein said cutting unit comprises a V-shape.

16. The cutting device of claim 11, wherein said cutting unit comprises a unitary molded plastic.

17. The cutting unit of claim 16, wherein said blade is configured to be removable.

18. The cutting unit of claim 17, wherein said blade is configured from said unitary molded plastic.

19. The cutting unit of claim one, wherein said second arm is configured to bias toward said first arm when a user is

20. The cutting unit of claim 11, wherein said blade is configured with a cutting surface, wherein said cutting surface and said inner surface of said second arm are configured to be parallel and touching when biased together.
